(19) United States
(12) Patent Application Publication
(10) Pub. No.: US 2026/0339111 A1
(43) Pub. Date: Oct. 29, 2026

(54) OPTICAL ELEMENT FOR IRRADIANCE REDISTRIBUTION, SENSOR AND DISPLAY APPARATUS

(71) Applicant: ams Sensors Germany GmbH, Jena (DE)

(72) Inventor: Stephan MALKMUS, Puchheim (DE)

(21) Appl. No.: 19/106,112

(22) PCT Filed: Jul. 27, 2023
(86) PCT No.: PCT/EP2023/070818

§ 371 Date: Feb. 24, 2025

(30) Foreign Application Priority Data
Aug. 26, 2022 (DE) 10 2022 121 629.2

(51) Int. Cl. G02B 27/09; G01S 7/481

(52) U.S. Cl. CPC G02B 27/0977; G01S 7/4814; G02B 27/0916; G02B 27/095

(57) ABSTRACT

An optical element comprises a transparent body with a flat light incoupling surface for coupling electromagnetic radiation into the transparent body and a flat light outcoupling surface for coupling the electromagnetic radiation out of the transparent body, a first reflective layer on a region of the light incoupling surface, a second reflective layer on a region of the light outcoupling surface, wherein the light incoupling and outcoupling surfaces are parallel, the first reflective layer comprises an opening through which the electromagnetic radiation is coupled into the transparent body, and the first reflective layer and the second reflective layer are arranged such that a geometric length of an optical path of the electromagnetic radiation inside the transparent body is at least three times larger than a distance between the light incoupling surface and the light outcoupling surface. Also described are a sensor and display apparatus comprising the optical element.

An optical element, a sensor and a display apparatus are specified herein.

At least one object of certain embodiments is to specify an optical element for an irradiance redistribution that is particularly compact. Furthermore, a sensor and a display apparatus comprising said optical element are specified herein.

According to at least one embodiment, the optical element comprises a transparent body with a flat light incoupling surface configured for coupling electromagnetic radiation into the transparent body and a flat light outcoupling surface configured for coupling the electromagnetic radiation out of the transparent body. In particular, the transparent body is at least partially transparent for the electromagnetic radiation. For example, at least 90% of the electromagnetic radiation coupled into the transparent body are transmitted through the transparent body. In other words, at most 10% of the electromagnetic radiation coupled into the transparent body via the light incoupling surface is not coupled out of the transparent body via the light outcoupling surface.

In particular, the light incoupling surface and the light outcoupling surface are planar and arranged on opposite sides of the transparent body. The transparent body comprises glass or a plastic material or a semiconductor material like silicon, or consists of one of these materials, for example. In particular, a transparent body comprising or consisting of silicon can be used for electromagnetic radiation with wavelengths in the short-wavelength infrared and/or mid-infrared spectral range with wavelengths of at least 1100 nm, for example.

The electromagnetic radiation may comprise wavelengths between infrared light and ultraviolet light, for example. For example, the electromagnetic radiation comprises or is electromagnetic laser radiation. Electromagnetic laser radiation is generated by a process of stimulated emission. Compared to electromagnetic radiation generated by spontaneous emission, electromagnetic laser radiation has a larger coherence length, a smaller spectral width, and/or a higher degree of polarization. Alternatively, the electromagnetic radiation coupled into the optical element may be focused or collimated electromagnetic radiation generated by spontaneous emission.

According to at least one further embodiment, the optical element comprises a first reflective layer on a region of the light incoupling surface. The first reflective layer is configured to reflect at least a part of the electromagnetic radiation propagating inside the transparent body. For example, a reflectance of the first reflective layer for the electromagnetic radiation is at least 80%, preferably at least 99%, and particularly preferably at least 99.9%.

The region of the light incoupling surface on which the first reflective layer is disposed may comprise a part of the light incoupling surface or the entire light incoupling surface. In particular, the first reflective layer comprises a metallic layer and/or a dielectric layer sequence, or consists of one or more of these layers. In particular, the dielectric layer sequence forms a Bragg mirror.

For example, the Bragg mirror comprises a sequence of alternating dielectric layers with different refractive indices. In particular, a thickness of the dielectric layers as well as a reflective index contrast between the alternating dielectric layers is adjusted such that the Bragg mirror has a high reflectance for the electromagnetic radiation.

According to at least one further embodiment, the optical element comprises a second reflective layer on a region of the light outcoupling surface. The second reflective layer is configured to reflect at least a part of the electromagnetic radiation propagating inside the transparent body. Preferably, a reflectance of the second reflective layer is smaller than the reflectance of the first reflective layer. Moreover, the second reflective layer preferably transmits at least a part of the electromagnetic radiation propagating inside the transparent body. For example, a reflectance of the second reflective layer for the electromagnetic radiation is at least 10%, preferably at least 50% and particularly preferably at least 80%. For example, a transmittance of the second reflective layer for the electromagnetic radiation is at most 90%, preferably at most 50% and particularly preferably at most 20%.

The region of the light outcoupling surface on which the second reflective layer is disposed may comprise a part of the light outcoupling surface or the entire light outcoupling surface. In particular, the second reflective layer comprises a metallic layer and/or a dielectric layer sequence, or consists of one or more of these layers. In particular, the dielectric layer sequence forms a Bragg mirror.

According to at least one further embodiment of the optical element, the light incoupling surface and the light outcoupling surface are parallel to each other. In particular, the light incoupling surface and the light outcoupling surface are parallel to each other within manufacturing tolerances. Here and in the following, the light incoupling surface and the light outcoupling surface are considered to be parallel if a direction normal to the light incoupling surface and a direction normal to the light outcoupling surface deviate by at most 5°, preferably by at most 1°. For example, the light incoupling surface and the light outcoupling surface are opposite surfaces of a planar transparent body. Alternatively, the light incoupling surface and the light outcoupling surface may form an angle between them. Moreover, the light incoupling surface and/or the light outcoupling surface may be curved.

According to at least one further embodiment of the optical element, the first reflective layer comprises an opening through which the electromagnetic radiation is coupled into the transparent body. In particular, the light incoupling surface is free of the reflective layer inside the opening. The opening may have an arbitrary shape, such as circular, elliptical, oval, square, rectangular, or polygonal, for example. In particular, a diameter of the opening in the first reflective layer is equal to or larger than a beam width of the electromagnetic radiation on the light incoupling surface. Here and in the following, the beam width of the electromagnetic radiation is defined as a radial diameter in a plane perpendicular to a propagation direction, where an intensity of the electromagnetic radiation has dropped to 13% of a maximum intensity within said plane.

For example, due to the opening in the first reflective layer only a small fraction of the electromagnetic radiation is reflected by the first reflective layer upon coupling the electromagnetic radiation into the transparent body. For example, less than 5%, preferably less than 1% of the electromagnetic radiation is reflected by the first reflective layer upon coupling the electromagnetic radiation into the transparent body.

According to at least one further embodiment of the optical element, the first reflective layer and the second reflective layer are arranged such that a geometric length of an optical path of the electromagnetic radiation inside the transparent body is at least three times larger than a distance between the light incoupling surface and the light outcoupling surface. In particular, the optical path corresponds to a light ray of the electromagnetic radiation that is coupled into the transparent body via the light incoupling surface and that is coupled out of the transparent body via the light outcoupling surface.

For example, at least a part of the electromagnetic radiation coupled into the transparent body via the light incoupling surface is reflected by the second reflective layer on the light outcoupling surface and redirected towards the first reflective layer on the light incoupling surface. The first reflective layer may further redirect most or all of the incident electromagnetic radiation towards the light outcoupling surface, where it is either coupled out of the transparent body or reflected again by the second reflective layer. In particular, at least a part of the electromagnetic radiation coupled into the transparent body may be reflected multiple times between the first reflective layer and the second reflective layer before being coupled out of the transparent body. Preferably, different reflected components of the electromagnetic radiation do not interfere within the transparent body. In other words, the optical path of the electromagnetic radiation inside the transparent body is such that there is little or no overlap between different reflected components of the electromagnetic radiation inside the transparent body.

According to a preferred embodiment, the optical element comprises:
a transparent body with a flat light incoupling surface configured for coupling electromagnetic radiation into the transparent body and a flat light outcoupling surface configured for coupling the electromagnetic radiation out of the transparent body,
a first reflective layer on a region of the light incoupling surface,
a second reflective layer on a region of the light outcoupling surface, wherein
the light incoupling surface and the light outcoupling surface are parallel to each other,
the first reflective layer comprises an opening through which the electromagnetic radiation is coupled into the transparent body, and
the first reflective layer and the second reflective layer are arranged such that a geometric length of an optical path of the electromagnetic radiation inside the transparent body is at least three times larger than a distance between the light incoupling surface and the light outcoupling surface.

The optical element described herein allows to redistribute an irradiance of the electromagnetic radiation by increasing a cross section and/or the beam width of the electromagnetic radiation, for example. In particular, the optical element may be used to decrease a maximum irradiance of the electromagnetic radiation in a vicinity of an emitter of the electromagnetic radiation, while beam properties of the electromagnetic radiation at large distances from the emitter remain almost unchanged.

Advantageously, the optical element may have a particularly small thickness and can be integrated in a compact package.

Here and in the following the thickness refers to a distance between the light incoupling surface and the light outcoupling surface of the optical element.

For example, the electromagnetic radiation is emitted by a sensor, such as a distance sensor for measuring a distance between the sensor and an external object. In particular, the electromagnetic radiation emitted by the sensor may pass through another element, such as a display screen, before being emitted towards the external object. If an irradiance of the electromagnetic radiation on the display screen is too large, a luminance of the display screen may be visibly distorted at a position, where the electromagnetic radiation passes through the display screen. Such visible distortions can be reduced or eliminated by redistributing the irradiance of the electromagnetic radiation on the display screen using the optical element disclosed herein. Moreover, a performance and/or a functionality of the sensor remains unaffected by the optical element, because properties of the electromagnetic radiation at large distances from the sensor are almost unaffected by the optical element.

According to at least one further embodiment the optical element reduces a maximum irradiance of the electromagnetic radiation on a reference plane downstream of the optical element by at least 50%, preferably by at least 90%. Here and in the following the irradiance specifies a radiant flux of the electromagnetic radiation received by a surface, such as the reference plane, per unit area. In particular, the irradiance is measured in W/m².

In particular, the reference plane refers to a plane downstream of the optical element, where the irradiance may be measured. Preferably, the reference plane is parallel to the light outcoupling surface. For example, a distance between the reference plane and the light outcoupling surface is smaller than or equal to the thickness of the optical element.

For example, due to the increased geometric length of the optical path of the electromagnetic radiation inside the transparent body, the beam width of the electromagnetic radiation coupled out of the optical element is increased. Consequently, the irradiance on the reference plane decreases compared to a situation, where no optical element as described herein is present.

According to at least one further embodiment of the optical element, a beam divergence of the electromagnetic radiation coupled out of the optical element is at most 20%, preferably at most 10%, larger or smaller than a beam divergence of the electromagnetic radiation coupled into the optical element.

Here and in the following the beam divergence is an angular measure of an increase of the beam width along a propagation direction of the electromagnetic radiation. In particular, the beam divergence specifies an opening angle of a cone, wherein most of the electromagnetic radiation propagates.

Preferably, the optical element does not change the beam divergence of the electromagnetic radiation. In other words, the optical element neither focuses, collimates nor defocuses the electromagnetic radiation.

Preferably, the electromagnetic radiation coupled into the optical element is incident on the light incoupling surface along a direction parallel to a surface normal of the light incoupling surface. In other words, the electromagnetic radiation is preferably incident on the light incoupling surface at an angle perpendicular to the light incoupling surface. Alternatively, the electromagnetic radiation may be coupled into the optical element at an arbitrary angle of incidence with respect to the light incoupling surface.

For example, the electromagnetic radiation is coupled into the optical element at an angle such that the electromagnetic radiation propagates inside the transparent body in lateral direction while being reflected multiple times between the first reflective layer and the second reflective layer before being coupled out of the optical element. Here and in the following “lateral” refers to a direction parallel to the light incoupling surface and/or parallel to the light outcoupling surface. In particular, while propagating in lateral directions, the beam width of the electromagnetic radiation increases, thereby reducing the irradiance at the light outcoupling surface.

According to at least one further embodiment of the optical element an anti-reflective coating is arranged on the light incoupling surface inside the opening in the first reflective layer. In particular, the anti-reflective coating is disposed directly on the light incoupling surface of the transparent body. For example, the anti-reflective coating reduces a part of the electromagnetic radiation that is reflected at the light incoupling surface upon coupling the electromagnetic radiation into the transparent body by at least 50%.

According to at least one further embodiment of the optical element a first refractive optical element is arranged on the light incoupling surface and covers the opening in the first reflective layer. For example, the first refractive optical element may be arranged directly on the light incoupling surface of the transparent body inside the opening of the first reflective layer, or the first refractive optical element may be arranged directly on the first reflective layer, such that it covers the opening. In particular, a region of the first reflective layer around the opening may be covered by the refractive optical element as well.

According to at least one further embodiment of the optical element, the first refractive optical element is configured to decrease an irradiance of the electromagnetic radiation on the light outcoupling surface. In particular, the first refractive optical element decreases a maximal irradiance of the electromagnetic radiation on the light outcoupling surface. For example, the first refractive optical element comprises a lens, a microlens, a lens array, and/or a microlens array.

Moreover, the first refractive optical element may be configured to reduce light losses. For example, the first refractive optical element is configured to reduce a part of the electromagnetic radiation that is reflected by the second reflective layer back towards the opening in the first reflective layer and thus may be coupled out of the optical element through the light incoupling surface.

According to at least one further embodiment of the optical element, the first refractive optical element comprises a concave conical lens or is a concave conical lens. In other words, the first refractive optical element comprises a concave axicon or is a concave axicon. In particular, the concave conical lens comprises a transparent material for the electromagnetic radiation, such as glass or a plastic, for example an epoxy. Moreover, the concave conical lens comprises a concave conical surface with a fixed apex angle. For example, the concave conical lens images a point light source onto a ring. Compared to a non-conical concave lens the concave conical lens has a higher adjustment tolerance and thus is easier to arrange on the light incoupling surface.

According to at least one further embodiment of the optical element, a first diffractive optical element is arranged on the light incoupling surface and covers the opening in the first reflective layer. For example, the first diffractive optical element may be arranged directly on the light incoupling surface of the transparent body inside the opening of the first reflective layer, or the first diffractive optical element may be arranged directly on the first reflective layer, such that it covers the opening. In particular, a region of the first reflective layer around the opening may be covered by the first diffractive optical element as well.

According to at least one further embodiment of the optical element, the first diffractive optical element is configured to decrease an irradiance of the electromagnetic radiation on the light outcoupling surface. In particular, the first diffractive optical element has the same functions as the first refractive optical element. All functional features of the first refractive optical element are also disclosed for the first diffractive optical element and vice versa.

For example, the first diffractive optical element comprises or consists of a concentric grating or of a meta-lens. For example, the meta-lens comprises a nano-structured surface. In particular, the nano-structured surface comprises an aperiodic array of nano-pillars configured for imparting a spatially dependent phase on the incident electromagnetic radiation. For example, the first diffractive optical element is realized by nano-imprinting of the light incoupling surface of the transparent, or by nano-imprinting of an at least partially transparent layer disposed on the light incoupling surface.

According to at least one further embodiment of the optical element, the second reflective layer comprises a first sub-region and a second sub-region, and a reflectance of the first sub-region differs from a reflectance of the second sub-region. In particular, the reflectance specifies a fraction of the incident electromagnetic radiation that is reflected by each respective sub-region. Preferably, the first sub-region and the second sub-region are directly adjacent to each other. For example, the second sub-region has a smaller reflectance than the first sub-region, or vice versa. For example, the first sub-region has a reflectance between 90% and 100% inclusive, whereas the second sub-region has a reflectance between 70% and 90% inclusive.

The second reflective layer may also comprise more than two sub-regions with different reflectances and/or transmittances. For example, the second reflective layer comprises a plurality of sub-regions with different reflectances for the electromagnetic radiation. The second reflective layer may also have a continuously varying reflectance gradient along a direction parallel to the light outcoupling surface. For example, the reflectance of the second reflective layer decreases continuously with an increasing radius away from a center of the second reflective layer.

According to at least one further embodiment of the optical element, the second sub-region completely surrounds the first sub-region in plan view of the light outcoupling surface. In particular, the first sub-region and the second sub-region are arranged concentrically. For example, the first sub-region has a circular shape and the second sub-region has an annular shape in plan view of the light outcoupling surface.

According to at least one further embodiment of the optical element a second refractive optical element is arranged on the second reflective layer and/or on the light outcoupling surface. For example, the second refractive optical element is a lens, a microlens, a lens array or a microlens array. Preferably, the second refractive optical element is arranged directly on the second reflective layer and/or directly on the light outcoupling surface of the transparent body.

According to at least one further embodiment of the optical element, the second refractive optical element is configured to reduce a beam divergence of the electromagnetic radiation coupled out of the optical element. For example, the first refractive optical element increases the beam divergence, whereas the second refractive optical element decreases the beam divergence, such that the electromagnetic radiation coupled out of the optical element has the same or a similar beam divergence as the electromagnetic laser radiation coupled into the optical element. In particular, the first refractive optical element and the second refractive optical element are configured such that the beam width of the electromagnetic radiation coupled out of the optical element is increased, while the beam divergence is unaffected by the optical element.

The second refractive optical element may be configured to adjust properties of the electromagnetic radiation coupled out of the optical element. In particular, the second refractive optical element is configured to adjust a beam divergence of the electromagnetic radiation. For example, the second refractive optical element may be configured to collimate and/or focus the electromagnetic radiation.

According to at least one further embodiment of the optical element, the second refractive optical element comprises a convex conical lens. In particular, the convex conical lens comprises a transparent material for the electromagnetic radiation, such as glass or a plastic, for example an epoxy. Moreover, the convex conical lens comprises a convex conical surface with a fixed apex angle.

Preferably, the convex conical lens comprises two or more Segments that are arranged concentrically. For example, each segment comprises a part of the convex conical surface and the segments are arranged in a staggered manner along an axial direction of the convex conical surface. In other words, the convex conical lens is a Fresnel-like lens. Preferably, in plan view of the light outcoupling surface a shape of a segment coincides and directly overlaps with a shape of a sub-region of the second reflective layer. In other words, each segment of the convex conical lens is arranged directly on a corresponding sub-region of the second reflective layer, for example. In particular, a part of the electromagnetic radiation that is transmitted through a sub-region of the second reflective layer further propagates through the corresponding segment of the convex conical lens.

According to at least one further embodiment of the optical element, an apex angle of the concave conical lens and an apex angle of the convex conical lens are equal. In particular, the apex angles are equal within manufacturing tolerances. For example, the apex angle of the convex conical lens and the apex angle of the concave conical lens may differ by at most 5°, preferably by at most 1°. By matching the apex angles of the convex conical lens and the concave conical lens, the beam width of the electromagnetic radiation coupled out of the optical element is increased, while the beam divergence of the electromagnetic radiation remains unaffected.

According to at least one further embodiment of the optical element, a second diffractive optical element is arranged on the second reflective layer and/or on the light outcoupling surface. Preferably, the second diffractive optical element is arranged directly on the second reflective layer and/or directly on the light outcoupling surface of the transparent body.

According to at least one further embodiment of the optical element, the second diffractive optical element is configured to reduce a beam divergence of the electromagnetic radiation coupled out of the optical element. In particular, the second diffractive optical element has the same functions as the second refractive optical element. All functional features of the second refractive optical element are also disclosed for the second diffractive optical element and vice versa.

For example, the second diffractive optical element comprises or consists of a concentric grating or of a meta-lens. For example, the meta-lens comprises a nano-structured surface. In particular, the nano-structured surface comprises an aperiodic array of nano-pillars configured for imparting a spatially dependent phase on the incident electromagnetic radiation. For example, the second diffractive optical element is realized by nano-imprinting of the light outcoupling surface of the transparent body, or by nano-imprinting of the second reflective layer disposed on the light outcoupling surface of the transparent body, or by nano-imprinting of an at least partially transparent layer disposed on the light outcoupling surface and/or on the second reflective layer.

Furthermore, a sensor is specified herein. Preferably, the sensor comprises an optical element as described herein. All features of the optical element are also disclosed for the sensor, and vice versa.

According to at least one embodiment the sensor comprises an optical element. In particular, the sensor comprises an optical element as described above.

According to at least one further embodiment, the sensor comprises an emitter for emitting electromagnetic radiation. For example, the emitter emits electromagnetic radiation with wavelengths between infrared light and ultraviolet light. In particular, the emitter comprises a laser diode or a light emitting diode. For example, the laser diode comprises an optical resonator and an epitaxial semiconductor layer stack with a pn-junction. The pn-junction together with the optical resonator is configured for converting an electric current into electromagnetic laser radiation. By contrast, the light emitting diode may not comprise a resonator and generates electromagnetic radiation by spontaneous emission.

According to at least one further embodiment the sensor comprises a detector configured for detecting at least part of the electromagnetic radiation reflected by an external object. In particular the electromagnetic radiation emitted by the emitter and coupled out of the sensor is partially reflected by the external object. At least a part of the reflected electromagnetic radiation is coupled into the sensor and detected by the detector. In particular, the detector converts the incident electromagnetic radiation into an electrical signal.

According to at least one further embodiment of the sensor, the emitter, the optical element and the detector are arranged such that the electromagnetic radiation emitted by the emitter passes through the optical element before being coupled out of the sensor, and the electromagnetic radiation coupled into the sensor does not pass through the optical element before impinging on the detector.

For example, the sensor is a distance sensor, a heartrate sensor, or an oxygen saturation sensor. In particular, the distance sensor measures a distance between the sensor and the external object. For example, the distance sensor measures a time-of-flight of a laser pulse that is emitted by the sensor towards the external object, reflected by the external object, and finally detected by the detector. Alternatively or in addition, the distance sensor may determine a distance to the external object by measuring an intensity of the detected electromagnetic radiation.

The heartrate sensor the oxygen saturation sensor may determine a heartrate or an oxygen saturation in blood by measuring a relative intensity change of the reflected electromagnetic radiation, for example.

According to at least one further embodiment of the sensor, the emitter comprises a vertical-cavity surface emitting laser diode. In particular, the vertical-cavity surface emitting laser diode emits electromagnetic laser radiation in a direction perpendicular to a main extension plane of semiconductor layers in the semiconductor layer stack. In other words, the electromagnetic laser radiation is emitted in a direction parallel to an epitaxial growth direction of the semiconductor layer stack.

Advantageously, a radial beam profile of the electromagnetic laser radiation emitted by the vertical-cavity surface emitting laser diode has a dip at a beam center. In other words, the intensity of the electromagnetic laser radiation is higher at small but finite emission angles compared to the intensity of the electromagnetic laser radiation emitted in a forward direction at an emission angle of zero degrees. The dip in the beam profile at the beam center can be advantageously used to decrease a fraction of the electromagnetic laser radiation that is back-reflected towards the emitter by the optical element and thus may be lost.

According to at least one further embodiment of the sensor, the detector comprises a photodiode, a phototransistor, a single-photon avalanche diode, a photodiode array and/or a single-photon avalanche diode array. For example, the detector comprises an epitaxial semiconductor layer stack with a pn-junction configured for converting incident electromagnetic radiation into an electrical output current. In particular, the photodiode array comprises a plurality of photodiodes arranged in a plane, for example. The single-photon avalanche diode array comprises a plurality of single-photon avalanche diodes arranged in a plane, for example.

Furthermore, a display apparatus is specified herein. Preferably, the display apparatus comprises a sensor as described above. All features of the sensor are also disclosed for the display apparatus, and vice versa.

According to at least one embodiment, the display apparatus comprises a sensor. In particular, the display apparatus comprises a sensor as specified above. For example, the sensor is a distance sensor, a heartrate sensor, and/or an oxygen saturation sensor.

According to at least one further embodiment, the display apparatus comprises a partially transparent display screen arranged such that the electromagnetic radiation emitted by the sensor is transmitted through the display screen before being coupled out of the display apparatus towards the external object. In particular, the display screen is at least partially transparent for the electromagnetic radiation emitted by the sensor.

For example, the display screen emits electromagnetic radiation in a visible spectral range. Preferably, the display screen and the sensor have equal or a similar emission directions for the respective electromagnetic radiation. For example, the sensor is a distance sensor and the display apparatus changes information shown on the display screen according to a distance between the sensor and an external observer.

According to at least one further embodiment of the display apparatus, the display screen comprises a plurality of individually addressable pixels. For example, the display screen is configured to display information in the form of an image. In particular, the plurality of individually addressable pixels is arranged in the form of a two-dimensional array.

According to at least one further embodiment of the display apparatus, each pixel comprises an organic light emitting diode and/or a micro-LED. In particular, the organic light-emitting diode comprises an organic functional layer stack configured for converting an electrical current into electromagnetic radiation. The organic functional layer stack comprises a layer with organic molecules that are organic semiconductors.

Alternatively or in addition, each pixel may comprise a light emitting semiconductor diode and/or a thin-film transistor. For example, the display screen is a micro-LED display or a thin-film transistor (TFT) liquid-crystal display. In particular, each pixel of the micro-LED display comprises a light emitting semiconductor diode with an edge length of at most 50 μm, preferably at most 20 μm. For example, each micro-LED has an edge length of approximately 12 μm.

According to at least one further embodiment of the display apparatus, the optical element reduces a maximum irradiance of the electromagnetic radiation emitted by the sensor on the display screen, such that a luminance of the display screen changes by at most 2%, preferably by at most 0.5%, due to the irradiation by the electromagnetic radiation. For example, the electromagnetic radiation emitted by the sensor may lead to a visible distortion of an image displayed on the display screen. Advantageously, the optical element reduces the maximum irradiance of the electromagnetic radiation on the display screen, such that no visible distortions can be observed on the display screen by an external observer. Moreover, the optical element preferably does not significantly alter a directional radiation characteristic of the emitter. Accordingly, a functionality of the sensor is not affected by the optical element.

Further advantageous embodiments and further embodiments of the optical element, the sensor and the display apparatus may become apparent from the following exemplary embodiments described in connection with the figures.

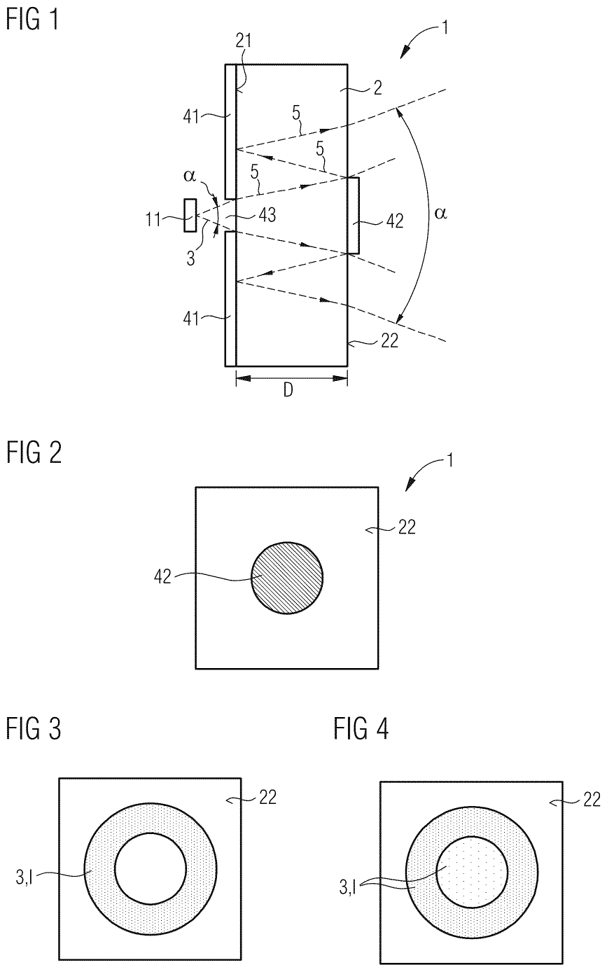

FIG. 1 shows a schematic cross section of an optical element according to an exemplary embodiment.

FIG. 2 shows a schematic plan view onto a light outcoupling surface of an optical element according to an exemplary embodiment.

FIGS. 3 and 4 show schematic irradiance distributions of electromagnetic laser radiation coupled out of an optical element according to an exemplary embodiment.

FIG. 5 shows a schematic cross section of an optical element according to a further exemplary embodiment.

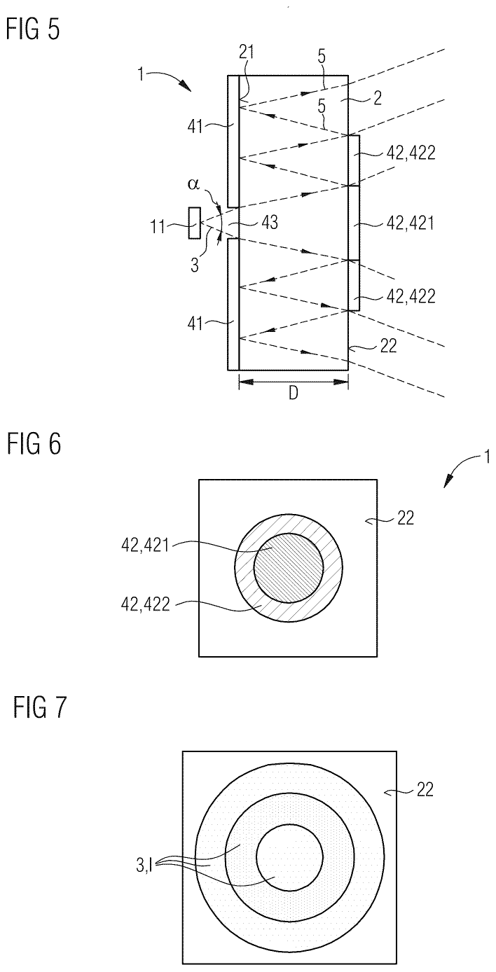

FIG. 6 shows a schematic plan view onto a light outcoupling surface of an optical element according to a further exemplary embodiment.

FIG. 7 shows a schematic irradiance distribution of electromagnetic laser radiation coupled out of an optical element according to a further exemplary embodiment.

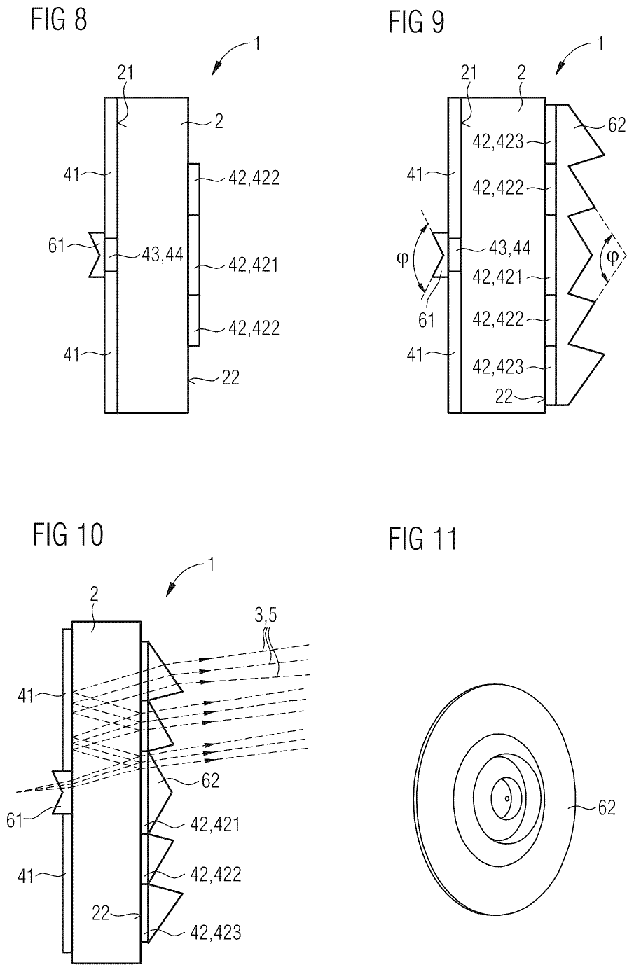

FIGS. 8 to 10 show schematic cross sections of optical elements according to further exemplary embodiments.

FIG. 11 shows a schematic perspective view of a second refractive optical element of an optical element according to an exemplary embodiment.

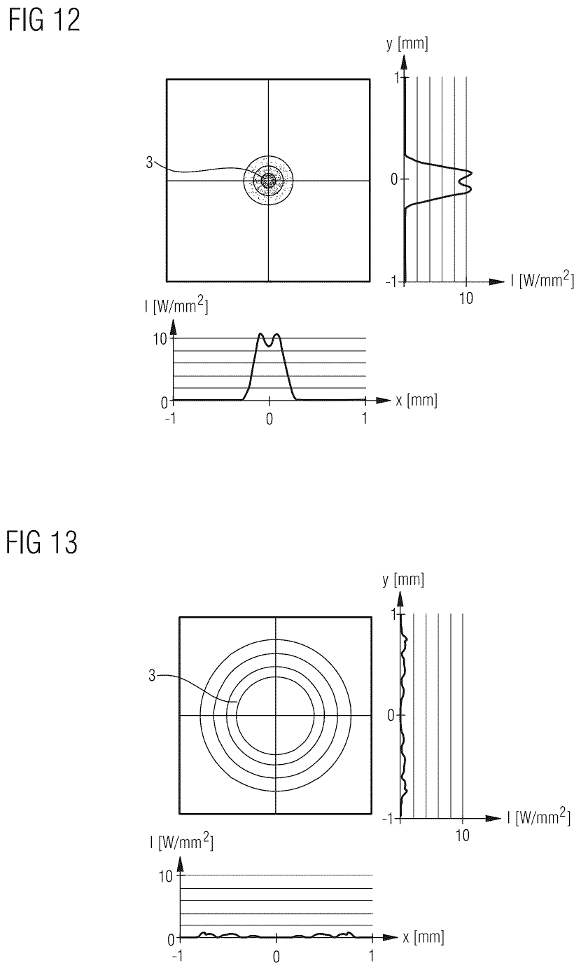

FIG. 12 shows a schematic irradiance distribution according to an example.

FIG. 13 shows a schematic irradiance distribution according to an exemplary embodiment.

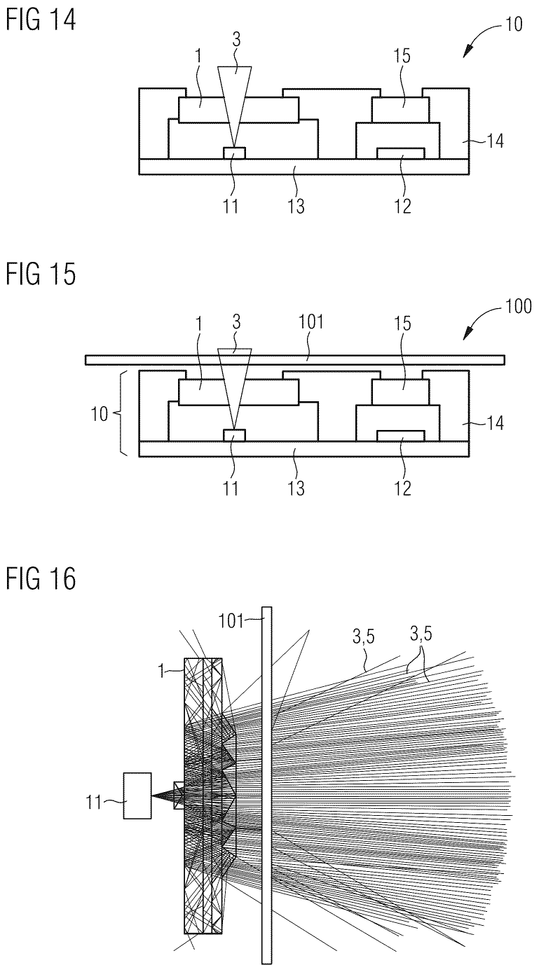

FIG. 14 shows a schematic cross section of a sensor according to an exemplary embodiment.

FIGS. 15 and 16 show schematic cross sections of a display apparatus according to exemplary embodiments.

Elements that are identical, similar, or have the same effect, are denoted by the same reference signs in the Figures. The Figures and the proportions of the elements shown in the Figures are not to be regarded as true to scale. Rather, individual elements, in particular layer thicknesses, may be shown exaggeratedly large for better representability and/or better understanding.

The optical element 1 according to the exemplary embodiment shown in FIG. 1 comprises a transparent body 2, a first reflective layer 41 and a second reflective layer 42. The transparent body 2 comprises glass and has planar light incoupling surface 21 and a planar light outcoupling surface 22 parallel to the light incoupling surface 21 on opposite sides of the transparent body 2.

The first reflective layer 41 is arranged directly on the light incoupling surface 21. The first reflective layer 41 covers the light incoupling surface 21 completely apart from an opening 43, through which electromagnetic laser radiation 3 is coupled into the transparent body 2. The opening 43 has a circular shape, or a shape matching a beam profile of the electromagnetic laser radiation 3. In particular, a diameter of the opening 43 is equal to or larger than a beam width of the electromagnetic laser radiation 3 on the light incoupling surface 21. The first reflective layer 41 comprises a metallic layer or a Bragg mirror and preferably has a reflectance of at least 99.9% for the electromagnetic laser radiation 3.

The second reflective layer 42 is arranged directly on the light outcoupling surface 22. It covers a circular shaped area of the light outcoupling surface 22 opposite to the opening 43 in the first reflective layer 41. The second reflective layer 42 comprises a metallic layer or a Bragg mirror and preferably has a reflectance of at least 80% for the electromagnetic laser radiation 3.

The electromagnetic laser radiation 3 is emitted by an emitter 11 that is not part of the optical element 1. The electromagnetic laser radiation 3 has a beam divergence α before being coupled into the optical element 1. The optical element 1 does not change the beam divergence α of the electromagnetic laser radiation 3. In particular, the electromagnetic laser radiation 3 coupled out of the optical element 1 has the same beam divergence α as the electromagnetic laser radiation 3 coupled into the optical element 1.

A diameter of the second reflective layer 42 is equal to a beam width of the electromagnetic laser radiation 3 on the light outcoupling surface 22 before the electromagnetic laser radiation 3 is at least partially reflected by the second reflective layer 42. In other words, all of the electromagnetic laser radiation 3 coupled into the transparent body 2 via the opening 43 in the first reflective layer 41 and transmitted through the transparent body 2 is incident on the second reflective layer 42.

Furthermore, FIG. 1 shows optical paths 5 or light rays of the electromagnetic laser radiation 3. In particular, at least a part of the electromagnetic laser radiation 3 coupled into the transparent body 2 through the opening 43 in the first reflective layer 41 propagates through the transparent body 2 and is reflected by the second reflective layer 42 back towards the first reflective layer 41. The first reflective layer 41 further redirects the electromagnetic laser radiation 3 towards the light outcoupling surface 22, where it is coupled out of the optical element 1.

Accordingly, a geometric length of at least some of the optical paths 5 inside the transparent body 2 is at least three times larger than a distance D between the first reflective layer 41 and the second reflective layer 42. Here, the distance D corresponds to a thickness of the transparent body 2. The optical element 1 thus changes an irradiance distribution of the electromagnetic laser radiation 3 at a fixed distance from the emitter 11. In particular, the beam width of the electromagnetic laser radiation 3 coupled out of the optical element 1 is increased by the optical element 1. Consequently, the irradiance of the electromagnetic laser radiation 3 is lowered by the optical element 1.

FIG. 2 shows a plan view onto the light outcoupling surface 22 of the optical element 1 according to the exemplary embodiment described in connection with FIG. 1. The second reflective layer 42 has a circular shape and covers only a part of the light outcoupling surface 22. A circular shaped second reflective layer 42 advantageously gives rise to an approximately radially symmetric beam profile of the electromagnetic laser radiation 3 coupled out of the optical element 1.

FIGS. 3 and 4 show schematic irradiance E distributions of the electromagnetic laser radiation 3 coupled out of the optical element 1 according to the exemplary embodiment described in connection with FIG. 1. In particular, FIGS. 3 and 4 show the irradiance E distribution in plan view of the light outcoupling surface 22 at a fixed distance from the light outcoupling surface 22.

The irradiance E distribution shown in FIG. 3 corresponds to an optical element 1, where both the first reflective layer 41 and the second reflective 42 layer have a reflectance of almost 100% and a transmittance of almost 0%. Accordingly, the electromagnetic laser radiation 3 has a ring-shaped irradiance E distribution, where the irradiance E is finite between the inner diameter and the outer diameter of the ring and the irradiance E approximately vanishes otherwise.

By contrast, the irradiance E distribution shown in FIG. 4 corresponds to an optical element 1, where the first reflective layer 41 has a reflectance of 100%, whereas the second reflective layer 42 has a reflectance of 90% and a transmittance of 10% for the electromagnetic laser radiation 3. Accordingly, compared to FIG. 3 the irradiance E is finite inside the inner diameter of the ring due to the part of the electromagnetic laser radiation 3 that is transmitted through the second reflective layer 42.

In contrast to FIG. 1, the optical element 1 according to the exemplary embodiment in FIG. 5 comprises a second reflective layer 42 with a first sub-region 421 and a second sub-region 422 directly adjacent to and completely surrounding the first sub-region 421. In particular, the first sub-region 421 is configured like the second reflective layer 42 described in connection with FIG. 1. The second sub-region 422 is ring-shaped and has an inner diameter matching the diameter of the first sub-region 421. The outer diameter of the second sub-region 422 is configured such that an optical path 5 of electromagnetic laser radiation 3 incident at the edge of the first sub-region 421 is redirected by the first reflective layer 41 towards an outer edge of the second sub-region 422 away from the first sub-region 421.

The first sub-region 421 has a reflectance of 90% and a transmittance of 10%, whereas the second sub-region 422 has a reflectance of 80% and a transmittance of 20% for the electromagnetic laser radiation 3. Accordingly, the optical element 1 shown in FIG. 5 has a broader irradiance distribution compared to the optical element 1 disclosed in connection with FIG. 1. In particular, some optical paths 5 of the electromagnetic laser radiation 3 have a geometric length that is at least five times larger than a distance D between the first reflective layer 41 and the second reflective layer 42.

FIG. 6 shows a plan view onto the light outcoupling surface 22 of the optical element 1 described in connection with FIG. 5. The second reflective layer 42 has a circular-shaped first sub-region 421 and an annular or ring-shaped second sub-region 422 directly adjacent to one another.

FIG. 7 shows a schematic irradiance E distribution of the electromagnetic laser radiation 3 coupled out of the optical element 1 according to the exemplary embodiment described in connection with FIG. 5. In particular, FIG. 7 shows the irradiance E distribution in plan view of the light outcoupling surface 22 at a fixed distance from the light outcoupling surface 22. The irradiance E distribution comprises a circular-shaped inner region and two concentric ring-shaped outer regions.

In particular, the inner circular-shaped region comprises electromagnetic laser radiation 3 transmitted through the first sub-region 421 of the second reflective layer 42, while the inner ring-shaped region comprises electromagnetic laser radiation 3 transmitted through the second sub-region 422 of the second reflective layer 42. The outer ring-shaped region of the irradiance E distribution comprises electromagnetic laser radiation 3 reflected by the second sub-region 422 of the second reflective layer 42 towards the first reflective layer 41 and further redirected by the latter towards the light outcoupling surface 22.

The optical element 1 according to the exemplary embodiment in FIG. 8 further comprises a first refractive optical element 61 compared to the embodiment described in connection with FIG. 5. The first refractive optical element 61 is a concave conical lens arranged on the light incoupling surface 21 of the transparent body 2. In particular, the concave conical lens covers the opening 43 in the first reflective layer 41 and configured to increase a beam diameter of the electromagnetic laser radiation 3. Between the first refractive optical element 61 and the light incoupling surface 21 an anti-reflective coating (44) may be arranged. Moreover, the concave conical lens reduces light losses by reducing a fraction of the electromagnetic laser radiation 3 that is reflected by the second reflective layer 42 and coupled out of the optical element 1 through the opening 43 in the first reflective layer 41 on the light incoupling surface 21.

Compared to the optical element disclosed in connection with FIG. 8, the optical element according to the exemplary embodiment in FIG. 9 further comprises a second reflective layer 42 with an additional third sub-region 423. The third sub-region 423 is arranged concentrically around the second sub-region 422. A reflectance and transmittance of the first, second and third-sub-regions 421, 422, 423 may be adjusted in order to achieve a more homogeneous irradiance distribution of electromagnetic radiation 3 coupled out of the optical element 1, for example.

Moreover, the optical element 1 comprises a second refractive optical element 62. The second refractive optical element 62 is a convex conical lens and arranged directly on the second reflective layer 42. The second refractive optical element 62 is configured to re-collimate the electromagnetic laser radiation 3. In particular, the second refractive optical element 62 reduces a beam divergence of the electromagnetic laser radiation 3. For example, the second refractive optical element 62 compensates an increase in the beam divergence due to the first refractive optical element 61. Advantageously, an apex angle φ of the conical surface of the first reflective optical element 61 is equal to the apex angle φ of the conical surface of the second refractive optical element 62 within manufacturing tolerances. By matching the apex angles φ of the concave conical lens and the convex conical lens the beam divergence of the electromagnetic laser radiation 3 passing through the optical element 1 remains unaffected by the optical element 1.

The convex conical lens is a Fresnel-like lens with a circular central segment surrounded by two concentric ring-shaped segments in plan view of the light outcoupling surface 22. Segments of the convex conical lens overlap with corresponding sub-regions of the second reflective layer 24 in plan view of the light outcoupling surface 22. By using a Fresnel-like convex conical lens the optical element 1 is advantageously more compact.

FIG. 10 shows optical paths 5 of electromagnetic laser radiation 3 passing through an optical element 1 according to the exemplary embodiment described in connection with FIG. 9. First the electromagnetic laser radiation 3 is deflected by the first refractive optical element 61 such that a beam width of the electromagnetic laser radiation 3 is increased inside the transparent body 2. Furthermore the electromagnetic laser radiation 3 is partially transmitted and partially reflected by the first sub-region 421 of the second reflective layer 42. The transmitted fraction of the electromagnetic laser radiation 3 is re-collimated by a first segment of the second refractive optical element 62 and coupled out of the optical element 1.

The fraction of the electromagnetic laser radiation 3 reflected by the first sub-region 421 is further redirected onto the second sub-region 422 by the first reflective layer 41. The electromagnetic laser radiation 3 incident on the second sub-region 422 is partially transmitted and partially reflected. The transmitted fraction is re-collimated by a segment of the second refractive optical element 62 and coupled out of the optical element 1. The reflected fraction is further redirected by the first reflective layer 41, coupled out through the third sub-region 423 and re-collimated by a third segment of the second refractive optical element 62 before being coupled out of the optical element 1. In this example, the third sub-region 423 does not reflect the incident electromagnetic radiation 3.

The second refractive optical element 62 of an optical element 1 according to an exemplary embodiment shown in FIG. 11 is a Fresnel-like convex conical lens. In particular, the convex conical lens comprises conical surface segments that are arranged concentrically in a staggered manner along an axial direction. Each conical surface segment has the same apex angle.

The irradiance E distribution shown in FIG. 12 corresponds to the irradiance E of the electromagnetic laser radiation 3 emitted by a vertical-cavity surface emitting laser diode (VCSEL). In particular, the irradiance E is shown as a contour plot across a surface perpendicular to the propagation direction of the electromagnetic laser radiation 3 at a fixed distance from the vertical-cavity surface emitting laser diode. Moreover, corresponding line plots of the irradiance E are shown along an x-direction and along a perpendicular y-direction.

The electromagnetic laser radiation 3 has an approximately circular beam profile and the irradiance E has a dip at the beam center. In other words, the electromagnetic laser radiation 3 emitted by the vertical-cavity surface emitting laser diode is not a Gauss-beam with an irradiance E maximum at the beam center. By contrast, the irradiance E is maximal along a ring-shaped contour that is concentric to the beam center.

The irradiance E distribution shown in FIG. 13 corresponds to the irradiance E of a vertical-cavity surface emitting laser diode as shown in FIG. 12 after being transmitted through an optical element 1 according to an exemplary embodiment. Compared to the irradiance E distribution shown in FIG. 12, the irradiance distribution in FIG. 13 thus has a larger spatial extension in x-and y-directions and a maximum irradiance E is lower.

The sensor 10 according to the exemplary embodiment shown in FIG. 14 comprises an emitter 11 and a detector 12 arranged on a carrier 13. The emitter 11 is a vertical-cavity surface emitting laser diode and the detector 12 is a photodiode, whereas the carrier 13 is a printed circuit board with electrical contacts for the emitter 11 and the detector 12. Alternatively, the emitter 11 may comprise a light emitting semiconductor diode and a focusing or collimation optics, for example.

During operation, the emitter 11 emits electromagnetic laser radiation 3 in a direction perpendicular to the carrier. The electromagnetic laser radiation 3 passes through an optical element 1 in order to re-distribute the irradiance E in lateral directions parallel to the main surface of the carrier 13. Electromagnetic laser radiation 3 that is reflected by an external object and is incident on the detector 12 does not pass through the optical element 1.

The optical element 1 is attached to the carrier 13 by a housing 14, such as a frame. For example, the housing 14, the optical element 1 and the carrier 13 form a hermetical seal to protect the emitter 11 from environmental impacts, such as humidity, harmful substances and/or mechanical forces. By employing the optical element 1 as a cover for the emitter 11, the sensor 10 can be incorporated into a particularly compact package. Similarly, a cover 15 is arranged above the detector 12. The cover 15 is a window that is transparent for the electromagnetic laser radiation 3 and protects the detector 12 from environmental impacts, such as humidity, harmful substances and/or mechanical forces.

The display apparatus 100 according to the exemplary embodiment shown in FIG. 15 comprises a sensor 10 as described in connection with the exemplary embodiment shown in FIG. 14, as well as a display screen 101. The display screen 101 is arranged above the sensor 10. The sensor 10 may also be arranged directly on the display screen 101. In particular, electromagnetic laser radiation 3 emitted by the sensor 10 is at least partially transmitted through the display screen 101 before propagating towards an external object.

The display screen 101 comprises a plurality of individually addressable pixels in order to display information in the form of an image, for example. Each pixel comprises an organic light emitting diode emitting electromagnetic radiation in a visible spectral range. By contrast, the sensor 10 emits electromagnetic laser radiation 3 in an infrared spectral range. For example the sensor 10 is a distance sensor configured to measure a distance between the display apparatus 101 and an external object. An emission direction of electromagnetic radiation by the display screen 101 coincides with the emission direction of electromagnetic laser radiation 3 by the sensor 10.

The optical element 1 in the sensor 10 is configured to reduce an irradiance of the electromagnetic laser radiation 3 on the display screen 101. In particular, the irradiance is reduced such that the electromagnetic laser radiation 3 does not cause a visible distortion in the image displayed on the display screen 101. A beam divergence of the electromagnetic laser radiation 3 is unaffected by the optical element 1, however, such that the sensor 10 remains functional.

FIG. 16 shows numerically simulated optical paths 5, or light rays, of electromagnetic laser radiation 3 emitted by an emitter 11 and passing through an optical element 1 and a display screen 101 of a display apparatus 100 according to an exemplary embodiment (the detector 12 of the display apparatus 100 is not shown in FIG. 16). The optical element 1 corresponds to the exemplary embodiment described in Connection with FIG. 9.

The optical element 1 increases a beam width and thus reduces an irradiance of the electromagnetic laser radiation 3 on the display screen 101. Optical properties of the electromagnetic laser radiation 3, such as the beam divergence, remain unchanged by the optical element 1.

This patent application claims the priority of German patent application DE 102022121629.2, the disclosure content of which is hereby incorporated by reference.

The invention is not restricted to the exemplary embodiments by the description on the basis of said exemplary embodiments. Rather, the invention encompasses any new feature and also any combination of features, which in particular comprises any combination of features in the patent claims and any combination of features in the exemplary embodiments, even if this feature or this combination itself is not explicitly specified in the patent claims or exemplary embodiments.

### REFERENCES

1 optical element
2 transparent body
21 light incoupling surface
22 light outcoupling surface
3 electromagnetic radiation
41 first reflective layer
42 second reflective layer
421 first sub-region
422 second sub-region
423 third sub-region
43 opening
44 anti-reflective coating
5 optical path
61 first refractive optical element
62 second refractive optical element
10 sensor
11 emitter
12 detector
13 carrier
14 housing
15 cover
100 display apparatus
101 display screen
D distance
E irradiance
α beam divergence
φ apex angle

1. An optical element comprising:
a transparent body with a flat light incoupling surface configured for coupling electromagnetic radiation into the transparent body and a flat light outcoupling surface configured for coupling the electromagnetic radiation out of the transparent body,
a first reflective layer on a region of the light incoupling surface,
a second reflective layer on a region of the light outcoupling surface, wherein
the light incoupling surface and the light outcoupling surface are parallel to each other,
the first reflective layer comprises an opening through which the electromagnetic radiation is coupled into the transparent body,
the first reflective layer and the second reflective layer are arranged such that a geometric length of an optical path of the electromagnetic radiation inside the transparent body is at least three times larger than a distance between the light incoupling surface and the light outcoupling surface, and
the first reflective layer and the second reflective layer are configured such that an irradiance distribution of electromagnetic laser radiation coupled into the optical element via the light incoupling surface and coupled out of the optical element via the radiation outcoupling surface is ring-shaped in plan view of the light outcoupling surface.

2. The optical element according to claim 1, wherein
the optical element reduces a maximum irradiance of the electromagnetic radiation on a reference plane downstream of the optical element by at least 50%.

3. The optical element according to claim 1, wherein
a beam divergence of the electromagnetic radiation coupled out of the optical element is at most 10% larger or smaller than a beam divergence of the electromagnetic radiation coupled into the optical element.

4. The optical element according to claim 1, wherein
an anti-reflective coating is arranged on the light incoupling surface inside the opening in the first reflective layer.

5. The optical element according to claim 1, wherein
a first refractive optical element and/or a first diffractive optical element is arranged on the light incoupling surface, and covers the opening in the first reflective layer, and
the first refractive optical element and/or the first diffractive optical element is configured to decrease an irradiance of the electromagnetic radiation on the light outcoupling surface.

6. The optical element according to claim 5, wherein
the first refractive optical element comprises a concave conical lens.

7. The optical element according to claim 1, wherein
the second reflective layer comprises a first sub-region and a second sub-region, and
a reflectance of the first sub-region differs from a reflectance of the second sub-region.

8. The optical element according to claim 7, wherein
the second sub-region completely surrounds the first sub-region in the plan view of the light outcoupling surface.

9. The optical element according to claim 1, wherein
a second refractive optical element and/or a second diffractive optical element is arranged on the second reflective layer and/or on the light outcoupling surface,
the second refractive optical element and/or the second diffractive optical element is configured to reduce a beam divergence of the electromagnetic radiation coupled out of the optical element.

10. The optical element according to claim 9, wherein
the second refractive optical element comprises a convex conical lens.

11. The optical element according to claim 10, wherein
an apex angle of a concave conical lens of a first refractive optical element arranged on the light incoupling surface and an apex angle of the convex conical lens of the second refractive optical element are equal.

12. A sensor comprising:
the optical element according to claim 1,
an emitter for emitting the electromagnetic radiation, and
a detector, configured for detecting at least a part of the electromagnetic radiation reflected by an external object, wherein
the emitter, the optical element and the detector are arranged such that the electromagnetic radiation emitted by the emitter passes through the optical element before being coupled out of the sensor, and the electromagnetic radiation coupled into the sensor does not pass through the optical element before impinging on the detector.

13. The sensor according to claim 12, wherein
the emitter comprises a vertical-cavity surface emitting laser diode, and
the detector comprises photodiode, a phototransistor, a single-photon avalanche diode, a photodiode array and/or a single-photon avalanche diode array.

14. A display apparatus, comprising:
the sensor according to claim 12, and
a partially transparent display screen arranged such that the electromagnetic radiation emitted by the sensor is transmitted through the display screen before being coupled out of the display apparatus towards the external object.

15. The display apparatus according to claim 14, wherein
the display screen comprises a plurality of individually addressable pixels, and
each pixel comprises an organic light emitting diode and/or a micro-LED.

16. The display apparatus according to claim 14,
wherein the optical element reduces a maximum irradiance of the electromagnetic radiation emitted by the sensor on the display screen, such that a luminance of the display screen changes by at most 2% due to the irradiation by the electromagnetic radiation.
